(19) United States
(12) Patent Application Publication
(10) Pub. No.: US 2026/0030512 A1
(43) Pub. Date: Jan. 29, 2026

(54) SYSTEMS, METHODS, AND MEDIA FOR TRAINING DISTRIBUTED NEURAL NETWORKS

(71) Applicant: The Trustees of Columbia University in the City of New York, New York, NY (US)

(72) Inventors: Xiao-Yang Liu, New York, NY (US); Xiaodong Wang, Ramsey, NJ (US)

(21) Appl. No.: 19/278,524

(22) Filed: Jul. 23, 2025

Related U.S. Application Data
(60) Provisional application No. 63/674,691, filed on Jul. 23, 2024.

(51) Int. Cl. G06N 3/098

(52) U.S. Cl. CPC G06N 3/098

(57) ABSTRACT

Mechanisms for training a distributed neural network are provided, the mechanisms including: for each of a plurality of sub-networks: performing, using a hardware processor, a transform on data in a data structure having at least two dimensions to provide training data having a higher dimensionality than the at least two dimensions; and training the sub-network using the training data independently of other of the plurality of subnetworks. In some of these embodiments, the at least two dimensions is two dimensions. In some of these embodiments, the training data is stored in a three-dimensional structure. In some of these embodiments, the transform is a discrete Fourier transform. In some of these embodiments, the transform is a discrete cosine transform.

### CROSS-REFERENCE TO RELATED APPLICATION

This application claims the benefit of U.S. Provisional Patent Application No. 63/674,691, filed Jul. 23, 2024, which is hereby incorporated by reference here in its entirety.

### BACKGROUND

Conventional distributed learning methods for training deep neural networks usually employ the distributed stochastic gradient descent (SGD) method to update network parameters, which will inevitably incur large communication overhead. For example, the distributed SGD method with a central node (a.k.a., a parameter server) to coordinate the parameter updates may involve O(HL·S) communication overhead, where H nodes collaborate in training a model of size S for L training epochs.

It is desirable to reduce or eliminate communication overhead for distributed deep learning.

Accordingly, new mechanisms for training distributed deep learning networks are desirable.

### SUMMARY

In accordance with some embodiments, mechanisms for training distributed deep learning networks are provided.

In some embodiments, systems for training a distributed neural network are provided, the systems comprising: memory; and at least one hardware processor coupled to the memory and collectively configured to at least: for each of a plurality of sub-networks: perform a transform on data in a data structure having at least two dimensions to provide training data having a higher dimensionality than the at least two dimensions; and train the sub-network using the training data independently of other of the plurality of subnetworks. In some of these embodiments, the at least two dimensions is two dimensions. In some of these embodiments, the training data is stored in a three-dimensional structure. In some of these embodiments, the transform is a discrete Fourier transform. In some of these embodiments, the transform is a discrete cosine transform. In some of these embodiments, the at least one hardware processor is further configured to map the training data from a data structure having a first dimensionality to a data structure having a higher dimensionality and fold the training data prior to training the sub-network.

In some embodiments, methods for training a distributed neural network are provided, the methods comprising: for each of a plurality of sub-networks: performing, using a hardware processor, a transform on data in a data structure having at least two dimensions to provide training data having a higher dimensionality than the at least two dimensions; and training the sub-network using the training data independently of other of the plurality of subnetworks. In some of these embodiments, the at least two dimensions is two dimensions. In some of these embodiments, the training data is stored in a three-dimensional structure. In some of these embodiments, the transform is a discrete Fourier transform. In some of these embodiments, the transform is a discrete cosine transform. In some of these embodiments, the method further comprises mapping the training data from a data structure having a first dimensionality to a data structure having a higher dimensionality and folding the training data prior to training the sub-network.

In some embodiments, non-transitory computer-readable media containing computer executable instructions that, when executed by a processor, cause the processor to perform a method for training a distributed neural network are provided, the method comprising: for each of a plurality of sub-networks: performing a transform on data in a data structure having at least two dimensions to provide training data having a higher dimensionality than the at least two dimensions; and training the sub-network using the training data independently of other of the plurality of subnetworks. In some of these embodiments, the at least two dimensions is two dimensions. In some of these embodiments, the training data is stored in a three-dimensional structure. In some of these embodiments, the transform is a discrete Fourier transform. In some of these embodiments, the transform is a discrete cosine transform. In some of these embodiments, the method further comprises mapping the training data from a data structure having a first dimensionality to a data structure having a higher dimensionality and folding the training data prior to training the sub-network.

### BRIEF DESCRIPTION OF THE DRAWINGS

FIG. 1 is an example of an architecture of a distributed neural network in accordance with some embodiments.

FIG. 2 is an example of a structure of a layer of a sub-network in accordance with some embodiments.

FIG. 3 is an example of another architecture of a distributed neural network in accordance with some embodiments.

FIG. 4 is an example of a first algorithm for training a neural network in accordance with some embodiments.

FIG. 5 is an example of a first algorithm for using a neural network to infer in accordance with some embodiments.

FIG. 6 is an example of a second algorithm for training a neural network in accordance with some embodiments.

FIG. 7 is an example of a second algorithm for using a neural network to infer in accordance with some embodiments.

FIG. 8 is an example of a third algorithm for training a neural network in accordance with some embodiments.

FIG. 9 is an example of a third algorithm for using a neural network to infer in accordance with some embodiments.

FIG. 10 is an example of hardware that can be used in accordance with some embodiments.

### DETAILED DESCRIPTION

In accordance with some embodiments, mechanisms for training distributed deep learning networks are provided.

In the following description, scalars, vectors, matrices and tensors are denoted by lowercase, boldface italics lowercase, boldface italics capital, and calligraphic letters, e.g., a∈ [symbol] , a∈ [symbol] ⁿ, A∈ [symbol] ⁿ^{₁}^{×n}^{₂}, A∈ [symbol] ⁿ^{₁}^{×n}^{₂}^{×n}^{₃}, respectively, and [symbol] (:, :, k), [symbol] (:, j, :), [symbol] (i, :, :) is used to denote the frontal, lateral, and horizontal slices of a tensor [symbol] . While this convention is used herein, any other suitable convention can be used in some embodiments.

Given an invertible discrete linear transform [symbol] : [symbol] ⁿ^{₃}→ [symbol] ⁿ^{₃}, let [symbol] and its inverse [symbol] ⁻¹ be taken along the third-dimension of third-order tensors. That is, for [symbol] ∈ [symbol] ⁿ₁^{×n}^{₂}^{×n}^{₃}, [symbol] ∈ [symbol] ( [symbol] )∈ [symbol] ⁿ^{₁}^{×n}^{₂}^{×n}^{₃}, with [symbol] (i, j, :)= [symbol] ( [symbol] (i, j, :)), i=1, . . . , n₁, j=1, . . . , n₂. And for [symbol] ∈ [symbol] ⁿ^{₁}^{×n}^{₂}^{×n}^{₃}, [symbol] = [symbol] ⁻¹( [symbol] ), with [symbol] (i, j, :)= [symbol] ⁻¹( [symbol] (i, j, :)), i=1, . . . , n₁, j=1, . . . , n₂.

In accordance with some embodiments, the general spectral tensor product can be defined as:

$$= \cdot ℬ = {ℒ}^{- 1} ( ℒ ( ) △ ℒ ( ℬ ) ) , \qquad ( 1 )$$

where Δ denotes the frontal-slice wise multiplication, i.e., for [symbol] ∈ [symbol] ⁿ^{₁}^{×n′×n}^{₃}, [symbol] ∈ [symbol] ^{n′×n}^{₂}^{×n}^{₃}, if [symbol] = [symbol] Δ [symbol] , then [symbol] (:, :, k)= [symbol] (:, :, k)Δ [symbol] (:, :, k), k=1, . . . , n₃. The t-product (tensor-tensor product) is a special case of equation (1) where the transform [symbol] is the discrete Fourier transform (DFT), in some embodiments.

### Fully Connected Spectral Tensor Network

In some embodiments, an N-layer fully connected neural network takes m input vectors each from [symbol] , which can be represented as a matrix X⁰∈ [symbol] . For example, in some embodiments, input vectors can represent color images of size n×n×3 and [symbol] ′₀=3n². The network can classify each input vector to one of the L classes, in some embodiments. For the forward pass, in some embodiments, a j-th layer of the network with weight W^{j}∈ [symbol] and offset B^{j}=[b^{j}, . . . , b^{j}]∈ [symbol] , where m=[b^{j}, . . . , b^{j}], can be represented as

$${X}^{j} = σ ( {W}^{j} \cdot {X}^{j - 1} + {B}^{j} ) , j = 1 , … , N - 1 , \qquad ( 2 )$$

where X^{j}∈ [symbol] , and σ(⋅) is an element-wise activation function, e.g., linear, sigmoid, ReLU, softmax, or any other suitable activation function. The last, i.e., N-th, layer of the network can produce an output Y∈ [symbol] ^{L×m} corresponding to the m input vectors, where

$${X}^{N} = {W}^{N} \cdot {X}^{N - 1} , \qquad ( 3 )$$

$$Y = f ( {X}^{N} ) , \qquad ( 4 )$$

and the output function f(X) operates on the columns of X, i.e., f(X(:, s)) maps X(:, s) to an output score vector Y(:, s)∈ [symbol] ^{L} representing the probabilities that the s-th input data vector X⁰ (:, s) belongs to different classes, in some embodiments. For example, in some embodiments, f(⋅) can be a softmax function or any other suitable output function.

In some embodiments, for a fully connected spectral tensor network, the m input data vectors can be organized as a tensor [symbol] ⁰∈ [symbol] . For an n×n×3 color image example, Q can be set to 3n, [symbol] ₀ can be set to n, and each image can be a lateral slice of [symbol] ⁰, in some embodiments. In some embodiments, using a weight tensor [symbol] ^{j}∈ [symbol] and an offset tensor [symbol] ^{j}∈ [symbol] , a fully connected tensor layer corresponding to equation (2) and equation (3) can become

$${j}^{} = ( {𝒲}^{j} \cdot {j - 1}^{} + {ℬ}^{j} ) , j = 1 , … , N - 1 , \qquad ( 5 )$$

$${N}^{} = {𝒲}^{N} \cdot {N - 1}^{} , \qquad ( 6 )$$

where [symbol] ^{j}∈ [symbol] , the spectral tensor product ⋅ is given in equation (1), and the tensor-activation function [symbol] (⋅) under transform [symbol] is defined by applying the conventional element-wise activation function σ(⋅) in the spectral domain, i.e.,

$$( ) = {ℒ}^{- 1} ( σ ( ℒ ( ) ) ) . \qquad ( 7 )$$

In some embodiments, the tensor layer in equations (5) and (6) can be equivalent to imposing a certain structure induced by the transform [symbol] on the weight matrix W in conventional networks in equations (2) and (3). For example, when [symbol] is a DFT, a block-circulant structure can be imposed on W, in some embodiments.

In som embodiments, all hidden layers in the network need not by in the form of equations (5) and (6). Some layers can take this form, while other layers can take conventional form, in some embodiments.

In some embodiments, such a tensor network can be split into two or more branches. For example, in some embodiments, for [symbol] ∈ [symbol] , denote [symbol] ∈ [symbol] as the transform of [symbol] along the third dimension, i.e., [symbol] (i, s, : )= [symbol] ( [symbol] (i, s, :)), i=1, . . . , [symbol] , s=1, . . . , m. Denote further \tilde{X}_{q}= [symbol] (:, :, q). Then, in some embodiments, according to equation (1), equations (5) and (6) can be split into Q branches of matrix computations

$${\tilde{X}}_{q}^{j} = σ ( {\tilde{W}}_{q}^{j} \cdot {\tilde{X}}_{q}^{j - 1} + {\tilde{B}}_{q}^{j} ) , \qquad ( 8 )$$

$$\begin{matrix}{\tilde{X}}_{q}^{N} = {\tilde{W}}_{q}^{N} \cdot {\tilde{X}}_{q}^{N - 1} , q = 1 , … , Q , \\ where {\tilde{X}}_{q}^{j} ∈ {ℂ}^{{ℓ}_{j} \times m} , {\tilde{B}}_{q}^{j} = [ {\tilde{b}}_{q}^{j} , … , {\tilde{b}}_{q}^{j} ] ∈ {ℂ}^{{ℓ}_{j} \times m} , m = [ {\tilde{b}}_{q}^{j} , … , {\tilde{b}}_{q}^{j} ] , and {\tilde{W}}_{q}^{j} ∈ {ℂ}^{{ℓ}_{j} \times {ℓ}_{j - 1}} .\end{matrix} \qquad ( 9 )$$

Any suitable number of branches can be used in some embodiments.

At the q-th branch, the output function f(⋅) can be applied to the output

$${\tilde{X}}_{q}^{N}$$

of the last layer, as in equation (4), i.e.,

$${Y}_{q} = f ( {\tilde{X}}_{q}^{N} ) , q = 1 , … , Q . \qquad ( 10 )$$

In some embodiments, the network output is the weighted sum of the outputs of the Q branches, i.e.,

$$Y = {\sum }_{q = 1}^{Q} {ω}_{q} {Y}_{q} , s . t . {ω}_{q} \geq 0 , {\sum }_{q = 1}^{Q} {ω}_{q} = 1. \qquad ( 11 )$$

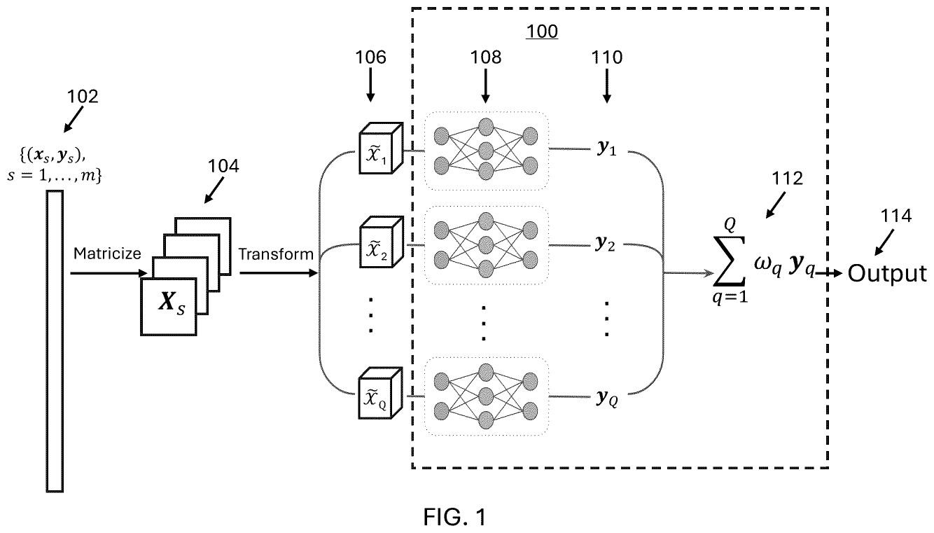

FIG. 1 illustrates an example 100 of a structure of a fully connected spectral tensor network, in accordance with some embodiments.

As shown, network 100 includes Q independent and fully connected sub-networks 108. Any suitable type and number of sub-networks 108 can be used in some embodiments. As shown, in some embodiments, the q-th sub-network takes as input the q-th column 106 of the transformed matrix \tilde{X} and produces a corresponding output score vector y_{q} 110. Finally, as shown, the network output score 114 is the weighted sum of all sub-network scores.

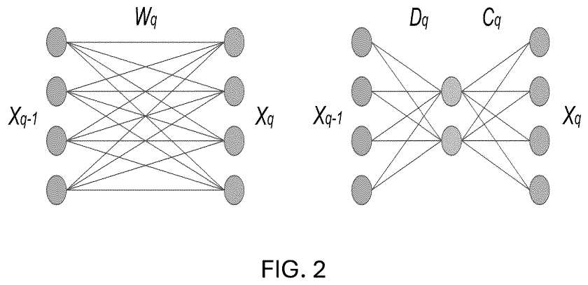

In accordance with some embodiments, FIG. 2 illustrates the structure of each layer of a sub-network, which under the low tubal-rank assumption, can be decomposed into two sub-layers. More particularly, in some embodiments, an N-layer fully connected spectral tensor network as described by equations (5) and (6) can be split into a 2N-layer network, as shown in FIG. 2, such that each layer is implemented by two sub-layers, i.e., W_{q}=C_{q}D_{q} where C_{q}∈ [symbol] and D_{q}∈ [symbol] with r< [symbol] ⱼ, [symbol] ⱼ₋₁.

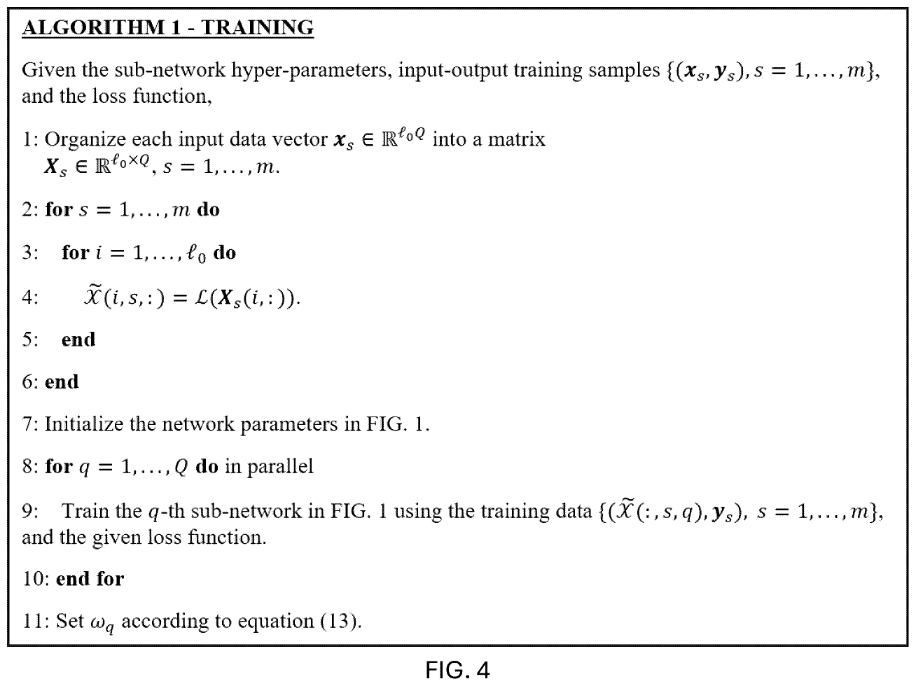

In accordance with some embodiments, as illustrated by the example algorithm of FIG. 4, network 100 can be trained through supervised learning using a training data set 102 that contains m samples, i.e., {(xₛ, yₛ), s=1, . . . , m}, where xₛ∈ [symbol] is the s-th data sample and yₛ∈ [symbol] ⁴ is the corresponding score vector such that if xₛ belongs to class c then yₛ(c)=1 and yₛ(c′)=0 for c′≠c.

In some embodiments, as shown at line 1 of FIG. 4, each input data vector xₛ∈ [symbol] can be organized into a matrix Xₛ∈E [symbol] 104. In some embodiments, the input data vector(s) can be matricized in any suitable manner to produce any suitable number of matrices (including only one) and size of matrices. For example, in some embodiments, network 100 can matricize vector xₛ 102 by slicing the vector along its length, and copying the slices of data into successive rows or columns of matrices Xₛ 104.

Next, as shown at lines 2-6 of FIG. 4, the transform along each row of Xₛ 104 can be taken to obtain \tilde{X}ₛ 106, where \tilde{X}ₛ=[ [symbol] (Xₛ (1,: )); . . . ; [symbol] (Xₛ( [symbol] ₀, :))], s=1, . . . , m. Any suitable transform(s) can be performed in any suitable manner, in some embodiments. For example, in some embodiments, a DFT transform, a Discrete Cosine Transform (DCT), a fast Fourier transform, a sparse Fourier transform, a discrete fractional Fourier transform, a short-time Fourier transform, a trigonometric interpolation polynomial, a discrete sine transform, a Laplace transform, a z-transform, a discrete wavelet transform, a Hankel transform, a Gabor transform, a Hadamard transform, a Shearlet transform, a quantum Fourier transform, and/or any other suitable transform can be performed.

This results in a tensor [symbol] being generated, where [symbol] ∈ [symbol] , where [symbol] (i, s, :)=\tilde{X}ₛ(i, :), i=1, . . . , [symbol] ₀, s=1, . . . , m.

Then, as shown in line 7 of FIG. 4, in some embodiments, the common parameters of the network can be specified. Any suitable parameters can be specified in some embodiments. For example, in some embodiments, the number of layers N, the dimensions of all layers [symbol] ⱼ, j=0, . . . , N, the rank value r, the activation function σ(⋅), the loss function, and/or any other suitable parameters can be specified. More particularly for example, in some embodiments, N can be 8, the ReLU activation function can be used as σ(⋅) in the hidden layers, the softmax function can be used as the output function f(⋅) in the last layer, the cross-entropy loss function in equation (12) can be used, the discrete cosine transform (DCT) can be used, the learning rate can be 0.01, the batch size can be 64, the Adam optimizer can be used, Q can be 4, n can be 49, and [symbol] ₀= . . . = [symbol] ₇=49, and r can be 8.

In some embodiments, to avoid exploding or vanishing gradients, the following initializations can be used:

$$\begin{matrix}{\tilde{C}}_{q}^{j} = randn ( {ℓ}_{j} , r ) \cdot \sqrt{2 / ( {ℓ}_{j} + r )} , \\ {\tilde{D}}_{q}^{j} = randn ( r , {ℓ}_{j - 1} ) \cdot \sqrt{2 / ( r + {ℓ}_{j - 1} )} , \\ {\tilde{B}}_{q}^{j} = {[ {\tilde{b}}_{q}^{j} , … , {\tilde{b}}_{q}^{j} ]}_{\underbrace{m}} ∈ {ℂ}^{{ℓ}_{j} \times m} , \\ {\tilde{b}}_{q}^{j} = randn ( {ℓ}_{j} , 1 ) \cdot \sqrt{2 / ( {ℓ}_{j} + 1 )} ,\end{matrix}$$

where randn(⋅) denotes the standard normal distribution.

In some embodiments, the loss function of network 100 can be a cross-entropy function as follows:

$$Loss = - {\sum }_{s = 1}^{m} {\sum }_{c = 1}^{L} 𝕝 ( {y}_{s} ( c ) = 1 ) \cdot ln ( Y ( c , s ) ) . \qquad ( 12 )$$

Then, as shown at lines 8-10 of FIG. 4, the Q independent sub-networks in FIG. 1 can be trained using any suitable technique for training a fully connected network, in some embodiments. Note that, in some embodiments, the training processes of the Q sub-networks are independent and training of the Q sub-networks can be implemented in parallel without communication between the networks.

The training data set for the q-th sub-network is {( [symbol] (:, s, q), yₛ), s=1, . . . , m}.

After the Q sub-networks are independently trained, the outputs of the Q sub-networks can be combined in the inference stage. Any suitable technique for combining the outputs can be used, in some embodiments. For example, in some embodiments, the outputs can be combined according to equation (11) using a weighted sum of the outputs. Any suitable weighting scheme can be used in some embodiments. For example, in some embodiments any of the following weighting schemes can be used:

$${ω}_{q} ∝ \{ \begin{matrix}1 / Q , & equal weight , \\ 1 / {Loss}_{q} , & weight inversely proportional to loss , \\ {p}^{a ( q ) ,} & geometric weight , \\ δ ( a ( q ) = 1 ) , & select - the - best ,\end{matrix} \qquad ( 13 )$$

where Loss_{q} denotes the loss value unpon convergence of the q-th sub-network, based on the training data {( [symbol] (:, s, q), yₛ), s=1, . . . , m}.

For geometric weights, in some embodiments, the Q sub-networks can be ordered according to Loss, in an ascending order, 1≤a(q)≤Q denotes the order of the q-th network, and p is a user-defined parameter.

In some embodiments, the “select-the-best” scheme retains only the best sub-network, i.e., the one with the lowest loss value.

In some embodiments, the geometric weighting scheme may yield the best inference performance. On the other hand, in some embodiments, the “select-the-best” scheme achieves an additional compression ratio of Q—for a total compression ratio of nQ²/2r, at the expense of some performance degradation.

The weights ω_{q} for combining the outputs of the sub-networks 108 of network 100 can be set at line 11 of FIG. 4.

In some embodiments, assuming that [symbol] ⱼ=n, then, for a conventional fully connected layer, the weight matrix W in equation (2) has dimension nQ×nQ; whereas for a fully connected spectral tensor layer, the weight tensor [symbol] in equation (5) has dimension n×n×Q. Hence, in some embodiments, the network parameter size can be reduced by a factor of Q due to the transform [symbol] -induced structure imposed on the weight matrix by the spectral tensor product. Further, in some embodiments, assuming a low tubal-rank structure, the network size can be reduced by a factor of nQ/2r.

If it is assumed that [symbol] ⱼ=n, for a conventional fully connected layer the weight matrix size is nQ× nQ and the computation complexity of each matrix-vector product is O(n²Q²). For the fully connected spectral tensor layer with Q sub-networks in the spectral domain as described above, the size of the spectral weight matrix in each sub-network is n×n without low-tubal rank assumption and n×r or r×n with low-tubal rank assumption, and the corresponding computational complexities are O(n²Q+n²QlogQ) and O(nrQ+n²QlogQ), respectively. Therefore, the fully connected spectral tensor layer's speed is improved by

$$O ( \frac{Q}{r / n + log Q} )$$

without low-tubal rank and

$$O ( \frac{Q}{1 + log Q} )$$

with low-tubal rank, respectively, compared to a conventional fully connected layer.

In some embodiments, depending on the adopted transform [symbol] , the sub-networks can be either real-valued (e.g., under DCT or Wavelet transforms) or complex-valued (e.g., under DFT).

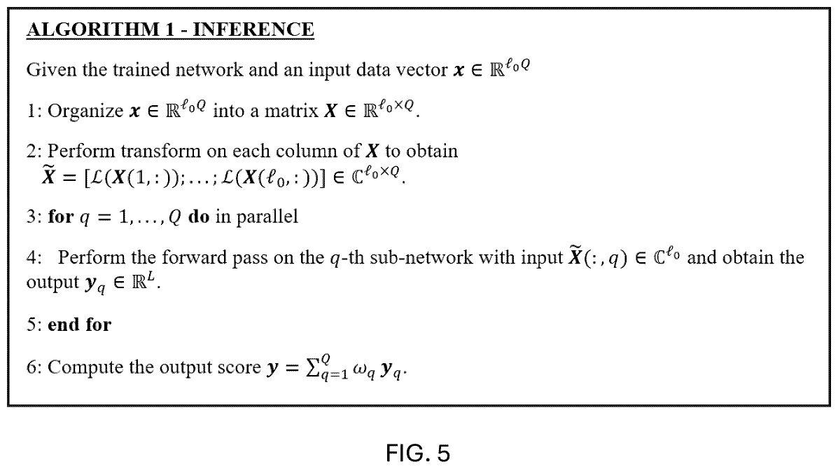

Once spectral tensor network 100 is trained, the network can be used to infer scores for input data. FIG. 5 shows an example algorithm for using network 100 to infer scores.

As shown at line 1 of FIG. 5, given a new data sample x∈ [symbol] , the data sample can first be matricized into X∈ [symbol] in the same manner as the training samples were matricized. Then, as shown at line 2 of FIG. 5, the resulting matrix can be transformed along each row in the same manner as performed when training to obtain \tilde{X}. Next, as shown at lines 3-5 of FIG. 5, for each of the Q sub-networks, the q-th column of \tilde{X}, i.e., \tilde{X}(:, q), can then be input to the q-th sub-network to produce the outputs y_{q}, where q=1, . . . , Q. Finally, as shown at line 6 of FIG. 5, the final output of the network can then be calculated as

$$y = {\sum }_{q = 1}^{Q} {ω}_{q} {y}_{q} .$$

In some embodiments, the above-described mechanism can be viewed as a form of ensemble deep learning in the sense that different spectral sub-networks are trained on different spectral data sets and these sub-networks are combined to achieve better overall generalization performance.

### Convolutional Spectral Tensor Network

Consider an example tensor [symbol] ∈ [symbol] ⁿ^{₁}^{×n}^{₂}^{×n}^{₃}. In some embodiments, a function bcirc( [symbol] )∈ [symbol] ⁿ^{₁}ⁿ^{₃}^{×n}^{₂}ⁿ^{₃} can be defined as organizing the n₃ frontal slices of [symbol] into a block-circulant matrix

$$bcirc ( ) = [ \begin{matrix}( : , : , 1 ) & ( : , : , {n}_{3} ) & … & ( : , : , 2 ) \\ ( : , : , 2 ) & ( : , : , 1 ) & … & ( : , : , 3 ) \\ ⋮ & ⋮ & ⋱ & ⋮ \\ ( : , : , {n}_{3} ) & ( : , : , {n}_{3} - 1 ) & … & ( : , : , 1 )\end{matrix} ] . \qquad ( 14 )$$

In some embodiments, a function unfold(⋅) can be defined as

$$unfold ( 𝒜 ) = {[ {𝒜 ( : , : , 1 )}^{T} , … , {𝒜 ( : , : , {n}_{3} )}^{T} ]}^{T} ∈ {ℝ}^{{n}_{1} {n}_{3} \times {n}_{2}} ,$$

and a function fold(⋅) can be defined as organizing it back to [symbol] , such that fold(unfold( [symbol] ))= [symbol] .

$$\text{?} \qquad ( 15 )$$

$$\text{?} \text{indicates text missing or illegible when filed}$$

Given [symbol] ∈ [symbol] ⁿ^{₁}^{×n′×n}^{₃} and [symbol] ∈ [symbol] ^{n′×n}^{₂}^{×n}^{₃}, in some embodiments, the t-product can be expressed as follows

$$𝒜 {*}_{t} ℬ = fold ( bcirc ( 𝒜 ) \cdot unfold ( ℬ ) ) ∈ {ℝ}^{{n}_{1} \times {n}_{2} \times {n}_{3}} .$$

The vec(⋅) operation can be defined as mapping a matrix in [symbol] ⁿ^{₁}^{×n}^{₂} into a vector in [symbol] ⁿ^{₁}ⁿ^{₂}, while the vec⁻¹(⋅) operation can be defined as performing the inverse mapping, in some embodiments.

In some embodiments, a convolutional neural network can take m input images (or any other suitable type of data) each of dimension H₀×W₀×C₀, where each image has a size H₀×W₀ and the number of channels is C₀, and represents them as a fourth-order tensor X⁰∈ [symbol] ^{H}^{₀}^{W}^{₀}^{×C}^{₀}^{×m}. In some embodiments, the input to the j-th layer can be defined is Xⁱ⁻¹∈ [symbol] ^{H}^{_{j−1}}^{×W}^{_{j−1}}^{×C}^{_{j−1}}^{×m}, which is processed by a convolutional kernel W^{j}∈ [symbol] ^{H}^{ⱼ}^{′×W}^{ⱼ}^{′×C}^{_{j−1}}^{×C}^{ⱼ} and an offset B^{j}∈ [symbol] ^{H}^{′×W}^{ⱼ}^{′×C}^{ⱼ}^{×m}, to yield Y^{j}∈ [symbol] ^{H}^{ⱼ}^{″×W}^{ⱼ}^{″×c}^{ⱼ}^{×m}, with

$${H}_{j}^{″} = {H}_{j - 1} - {H}_{j}^{′} + 1 , {W}_{j}^{″} = {W}_{j - 1} - {W}_{j}^{′} + 1 ,$$

where

$${Y}^{j} ( h , w , c , : ) = {\sum }_{d = 1}^{{C}_{j - 1}} {\sum }_{ℓ = 0}^{{W}_{j}^{′} - 1} {\sum }_{i = 0}^{{H}_{j}^{′} - 1} {X}^{j - 1} ( h + i , w + ℓ , d , : ) \cdot {W}^{j} ( i , ℓ , d , c ) + {B}^{j} ( h , w , c , : ) , \qquad ( 17 )$$

$$h = 1 , … , {H}_{j}^{″} , w = 1 , … , {W}_{j}^{″} , c = 1 , … , {C}_{j} .$$

In some embodiments, in equation (17), when using a stride t=1, the kernel can be convolved with the input at every possible spatial location. When stride t>1, every movement of the kernel can skip t−1 pixel locations (i.e., the convolution is performed once every t pixels both horizontally and vertically), in some embodiments. In some embodiments, when a kernel does not perfectly fit the input, the input can be padded with zeros, called zero-padding, or the part of the input where the kernel does not fit can be dropped, called valid padding.

In some embodiments, a nonlinear function can then take the feature map in equation (17) and produce the activation map

$${Z}^{j} = σ ( {Y}^{j} ) ∈ {{H}_{j}^{″} \times {W}_{j}^{″} \times {C}_{j} \times m}^{} , \qquad ( 18 )$$

where the activation function σ(⋅) is an element-wise operation as in equation (2). In some embodiments, a pooling operation can then be applied to Z^{j} channel by channel independently. Within each channel, the matrix with

$${H}_{j}^{″} and {W}_{j}^{″}$$

elements can be divided into Hⱼ×Wⱼ nonoverlapping subregions, each subregion being H×W in size, in some embodiments. The pooling operator can then map a subregion into a single number, in some embodiments. In some embodiments, two types of pooling operators can be used: max pooling where a subregion is mapped to its maximum value; and average pooling where a subregion is mapped to its average value. Hence, in some embodiments, the output of the j-th layer can be X^{j}∈ [symbol] ^{H}^{ⱼ}^{×W}^{ⱼ}^{×C}^{ⱼ}^{×m} which is the input to the (j+1)-th layer.

Finally, in some embodiments, the last, i.e., N-th layer, can output a score Y∈ [symbol] ^{L×m}

$$Y = f ( {X}^{N} ) , \qquad ( 19 )$$

$$or Y ( ; , s ) = f ( vec ( unfold ( {X}^{N} ( : , : , : , s ) ) ) , s = 1 , … , m$$

that can be used in any suitable manner, such as to reflect a classification of the input.

In some embodiments, a convolutional spectral tensor network can implement equation (17) represented as a matrix product form that is similar to equation (2)

$${Y}^{j} = {W}^{j} \cdot {X}^{j - 1} + {B}^{j} , \qquad ( 20 )$$

formed from Y^{j}∈ [symbol] ^{H}^{′W}^{ⱼ}^{′C}^{ⱼ}^{×m}, W^{j}∈ [symbol] ^{H}^{ⱼ}^{′W}^{′C}^{ⱼ}^{×H}^{_{j−1}}^{W}^{_{j−1}}^{C}^{_{j−1}}, and X^{j-1}∈ [symbol] ^{H}^{_{j−1}}^{W}^{_{j−1}}^{C}^{_{j−1}}^{×m} are formed from Y^{j}, W^{j} and X^{j-1}. In particular,

$$\begin{matrix}{Y}^{j} ( : , s ) = vec ( unfold ( {Y}^{j} ( : , : , : , s ) ) ) , \\ {X}^{j - 1} ( : , s ) = vec ( unfold ( {X}^{j - 1} ( : , : , : , s ) ) ) , s = 1 , … , m .\end{matrix} \qquad ( 21 )$$

Assuming that Cⱼ=nB for j=0, . . . , N, then, in some embodiments, similar to equations (5) and (6), equation (20) leads to a convolutional tensor layer

$${𝒴}^{j} = {𝒲}^{j} \cdot {𝒳}^{j - 1} + {ℬ}^{j} , \qquad ( 22 )$$

where [symbol] ^{j}∈ [symbol] ^{H}^{ⱼ}^{″W}^{ⱼ}^{″n×m×B}, [symbol] ^{j}∈ [symbol] ^{H}^{ⱼ}^{′W}^{ⱼ}^{′n×H}^{_{j−1}}^{W}^{_{j−1}}^{n×B}, [symbol] ^{j}∈ [symbol] ^{H}^{_{j−1}}^{W}^{_{j−1}}^{″n×m×B}, and [symbol] ^{j}∈ [symbol] ^{H}^{ⱼ}^{′W}^{ⱼ}^{′n×m×B}.

Consider the case when [symbol] is a DFT, according to equation (16), equation (22) can be written as equation (20) where Y^{j}=unfold( [symbol] ^{j}), X^{j-1}=unfold( [symbol] ^{j-1}), B^{j}=unfold( [symbol] ^{j}), and W^{j}=bcirc( [symbol] ^{j})∈ [symbol] ^{H}^{ⱼ}^{40 W}^{ⱼ}^{′nB×H}^{_{j−1}}^{W}^{_{j−1}}^{nB} has a block-circulant structure, namely B×B blocks organized in a circulant form and each block has size

$${H}_{j}^{″} {W}_{j}^{″} n \times {H}_{j - 1} {W}_{j - 1} n ,$$

in some embodiments. Recall that W^{j} in equation (20) is derived from the convolutional kernel W^{j}∈ [symbol] ^{H}^{ⱼ}^{′×W}^{ⱼ}^{′×nB×nB} in equation (17), following a linear mapping that is consistent with equation (21). Therefore, the block-circulant structure of W^{j} in equation (20) implies a block-circulant structure of each matrix W^{j}(i, [symbol] , :, :) in equation (17).

In some embodiments, the convolutional tensor layer in equation (22) is equivalent to imposing a certain structure induced by the transform [symbol] on the last two dimensions of the weight tensor W^{j}∈ [symbol] ^{H}^{ⱼ}^{′×H}^{ⱼ}^{′×nB×nB} in equation (17). For example, in some embodiments, when [symbol] is a DFT, the block-circulant structure can be imposed on the last two dimensions of W^{j}, namely, W^{j}(i, [symbol] , :, :) has B×B blocks organized in a circulant form and each block has size n×n,

$$i = 1 , … , {H}_{j}^{′} , ℓ = 1 , … , {W}_{j}^{′} .$$

In some embodiments, a convolutional spectral tensor network can also feature a parallel implementation. Specifically, for [symbol] ∈ [symbol] ^{HWn×m×B}, [symbol] = [symbol] ( [symbol] )∈ [symbol] ^{HWn×m×B} can be denoted as the transform of [symbol] along the third dimension, in some embodiments. In some embodiments, \tilde{X}_{b} can be defined as [symbol] (:, :, b). Then, in some embodiments, equation (22) can be split into B parallel branches of matrix computations as follows

$${\tilde{Y}}_{b}^{j} = {\tilde{W}}_{b}^{j} \cdot {\tilde{X}}_{b}^{j - 1} + {\tilde{B}}_{b}^{j} , b = 1 , … , B , \qquad ( 23 )$$

$$where {\tilde{Y}}_{b}^{j} ∈ {ℂ}^{{H}_{j}^{″} {W}_{j}^{″} n \times m} , {\tilde{W}}_{b}^{j} ∈ {ℂ}^{{H}_{j}^{″} {W}_{j}^{″} n \times {H}_{j - 1} {W}_{j - 1} n} , and {\tilde{X}}_{b}^{j - 1} ∈ {ℂ}^{{H}_{j - 1} {W}_{j - 1} n \times m} .$$

In some embodiments, equation (23) can be converted back to a convolutional form in equation (17), using an inverse mapping of equation (21) as follows

$$\begin{matrix}{\tilde{Y}}_{b}^{j} ( : , : , : , s ) = fold ( {vec}^{- 1} ( {\overline{y}}_{b}^{j} ( : , s ) ) ) , \\ {\tilde{X}}_{b}^{j - 1} ( : , : , : , s ) = fold ( {vec}^{- 1} ( {\overline{X}}_{b}^{j - 1} ( : , s ) ) ) , s = 1 , … , m .\end{matrix} \qquad ( 24 )$$

In some embodiments, for the b-th branch in equation (23), the input is

$${ℂ}^{{H}_{j - 1} \times {W}_{j - 1} \times n \times m} ,$$

the output feature map is \tilde{Y}_{b}∈ [symbol] ^{H}^{ⱼ}^{′×W}^{ⱼ}^{′×n×m}, and the kernel weight is

$${ℂ}^{{H}_{j}^{′} \times {W}_{j}^{′} \times n \times n} .$$

Then, in some embodiments, for b=1, . . . , B, equation (23) can be rewritten as

$${\tilde{Y}}_{b}^{j} ( h , w , c , : ) = {\sum }_{d = 1}^{n} {\sum }_{ℓ = 0}^{{W}_{j}^{′} - 1} {\sum }_{i = 0}^{{H}_{j}^{′} - 1} {\tilde{X}}_{b}^{j - 1} ( h + i , w + ℓ , d , : ) \cdot {\tilde{W}}_{b}^{j} ( i , ℓ , d , c ) + {\tilde{B}}_{b}^{j} ( h , w , c , : ) , \qquad ( 25 )$$

$$h = 1 , … , {H}_{j}^{″} , w = 1 , … , {W}_{j}^{″} , c = 1 , … , n .$$

In some embodiments, assuming Cⱼ=nB, j=0, . . . , N, for a convolutional layer, the kernel W^{j} in equation (17) can have dimensions

$${H}_{j}^{′} \times {W}_{j}^{′} \times nB \times nB ;$$

whereas for a convolutional spectral tensor layer, the weight tensor

$${\tilde{W}}_{b}^{j}$$

of teh b-th branch in equation (25) can have dimensions

$${H}_{j}^{′} \times {W}_{j}^{′} \times n \times n , b = 1 , … , B .$$

Hence, the network parameter size for each branch can be reduced by a factor of B², which is due to the transform [symbol]
-induced structure imposed on the weight tensor W^{j} in equation (17) by the spectral tensor product, in some embodiments.

In some embodiments, the activation function in the spectral domain can be applied as follows

$${\tilde{Z}}_{b}^{j} = σ ( {\tilde{Y}}_{b}^{j} ) ∈ {ℂ}^{{H}_{j}^{″} \times {W}_{j}^{″} \times n \times m} . \qquad ( 26 )$$

Then, in some embodiments, a pooling operation can be performed at the j-th layer of each branch, resulting in the output

$${\tilde{X}}_{b}^{j} ∈ {ℂ}^{{H}_{j} \times {W}_{j} \times n \times m} .$$

At the last layer, in some embodiments, the output function f(⋅) can be applied to

$${\tilde{X}}_{b}^{N} ,$$

as in equation (19), i.e.,

$$\begin{matrix}{Y}_{b} = f ( {\tilde{X}}_{b}^{N} ) , \\ or {Y}_{b} ( : , s ) = f ( vec ( unfold ( {\tilde{X}}_{b}^{N} ( : , : , : , s ) ) ) , s = 1 , … , m .\end{matrix} \qquad ( 27 )$$

Finally, in some embodiments, the network output is the weighted sum of the outputs of the B branches, i.e.,

$$Y = {\sum }_{b = 1}^{B} {ω}_{b} {Y}_{b} , s . t . {ω}_{b} \geq 0 , {\sum }_{b = 1}^{B} {ω}_{b} = 1. \qquad ( 28 )$$

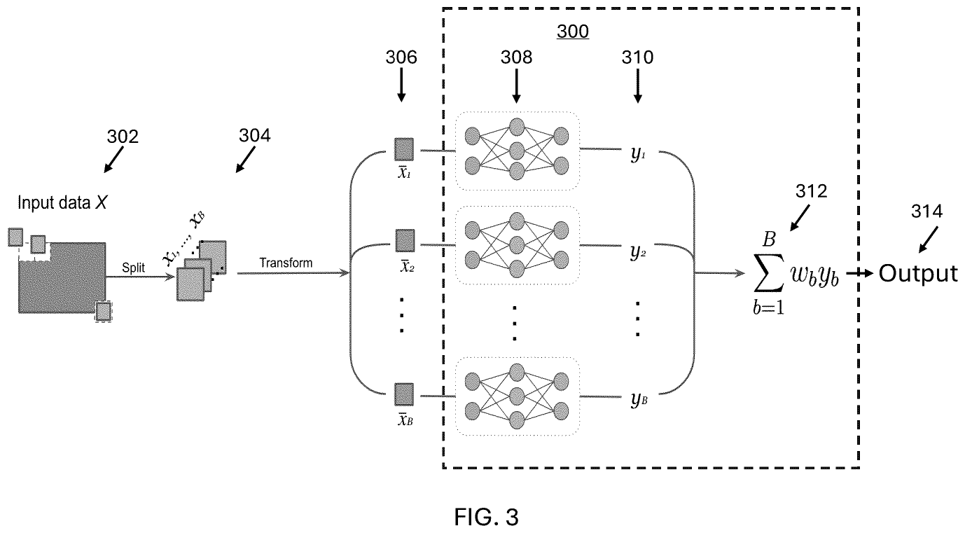

FIG. 3 illustrates an example 300 of a structure of a convolutional tensor spectral network, in accordance with some embodiments.

As shown, network 300 includes B independent convolutional sub-networks 308. Any suitable type and number of sub-networks 308 can be used in some embodiments. As shown, in some embodiments, the b-th sub-network takes as input sub-tensor \tilde{X}_{b} 306 and produces a corresponding output score vector Y_{b} 310. Finally, as shown, the network output score is the weighted sum of all sub-network scores.

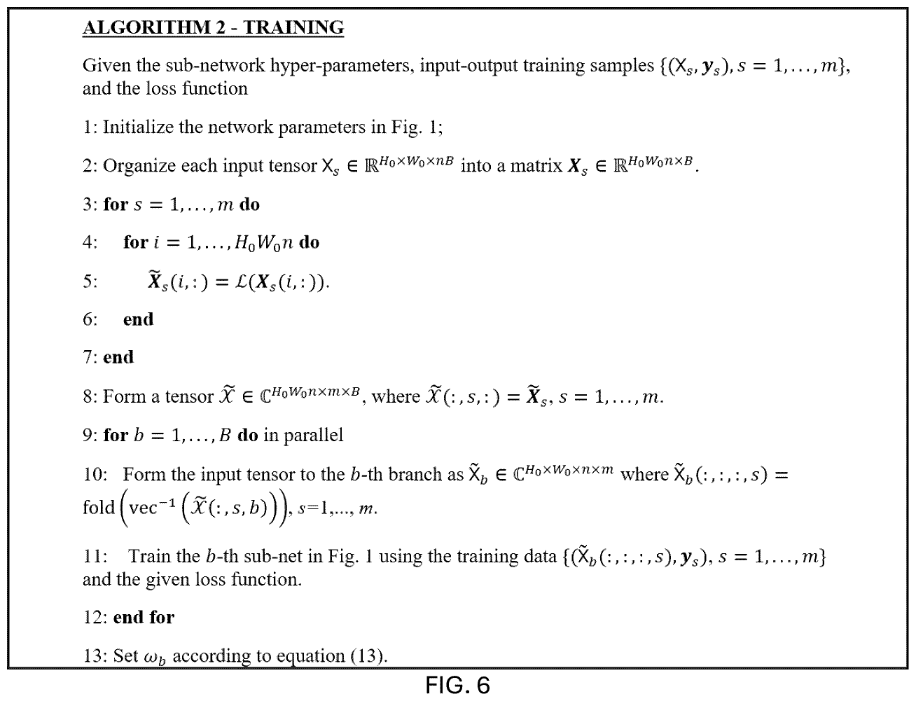

In accordance with some embodiments, as illustrated by the example algorithm of FIG. 6, network 300 can be trained through supervised learning using a training data set 302 that contains m samples, i.e., {(Xₛ, yₛ), s=1, . . . , m}, where Xₛ∈ [symbol] ^{H}^{₀}^{×W}^{₀}^{×nB} is the s-th data sample and yₛ∈ [symbol] ^{L} is the corresponding score.

In some embodiments, as shown at line 1 of FIG. 6, the network parameters of network 100 can be initialized. Any suitable network parameters of network 100 can be initialized in any suitable manner, in some embodiments. For example, in some embodiments, the number of layers N, the convolutional kernel sizes

$${H}_{j}^{′} \times {W}_{j}^{′} \times n \times n ,$$

the activation function σ(⋅), the pooling function, and the loss function can be specified. More particularly for example, in some embodiments, N can be 8, the ReLU activation function can be used as σ(⋅) in the hidden layers, the softmax function can be used as the output function f(⋅) in the last layer, the cross-entropy loss function in equation (12) can be used, the discrete cosine transform (DCT) can be used, the learning rate can be 0.01, the batch size can be 64, 128, 256, or any other suitable value, the Adam optimizer can be used, the number channels c can be 16, B can be 4, n can be 49, and [symbol] ₀= . . . = [symbol] ₇=49, and r can be 8.

In some embodiments, to avoid exploding or vanishing gradients, the following initializations can be applied

$$\begin{matrix}{\tilde{W}}_{b}^{j} = randn ( {H}_{{j}^{′}} , {W}_{{j}^{′}} , n , n ) \sqrt{2 / ( {H}_{{j}^{′}} + {W}_{{j}^{′}} + 2 n )} , \\ {\tilde{B}}_{b}^{j} ( : , : , : , s ) = randn ( {H}_{j} , {W}_{j} , n ) \sqrt{2 / ( {H}_{j} + {W}_{j} + n )} ,\end{matrix}$$

$$where s = 1 , … , m .$$

In some embodiments, the sub-networks can each take a similar structure of AlexNet, ResNet34, or ResNet50. For example, in some embodiments, AlexNet consists of 3 fully-connected layers and 5 convolutional layers, containing 60 million parameters. In some embodiments, B can be 4 or 16. As another example, in some embodiments, ResNet34 can have 34 layers and ResNet50 can have 50 layers.

Next, as shown at line 2 of FIG. 6, each input tensor Xₛ∈ [symbol] ^{H}^{₀}^{×W}^{₀}^{×nB} can be organized into a matrix Xₛ∈ [symbol] ^{H}^{₀}^{W}^{₀}^{n×B}. This organizing can be performed in any suitable manner, in some embodiments. For example, in some embodiments, one way of performing the organizing can be: in the third dimension, there is nB; split this into B groups. More particularly, for example, if Xₛ is 32×32×32 with nB=32; and n can be set to 8 and B can be set to 4, and then this third-order tensor can be organized into a matrix of size 8192×4, in some embodiments.

Then, as shown at lines 3-7 of FIG. 6, a transform on each row of Xₛ can be taken to obtain

$${\tilde{X}}_{s} = [ \begin{matrix}ℒ ( {X}_{s} ( 1 , : ) ) \\ ⋮ \\ ℒ ( {X}_{s} ( {H}_{0} {W}_{0} n , : ) )\end{matrix} ] , \qquad ( 29 )$$

where s=1, . . . , m. Any suitable transform can be performed in any suitable manner, in some embodiments. For example, in some embodiments, a DFT transform, a Discrete Cosine Transform (DCT), a fast Fourier transform, a sparse Fourier transform, a discrete fractional Fourier transform, a short-time Fourier transform, a trigonometric interpolation polynomial, a discrete sine transform, a Laplace transform, a z-transform, a discrete wavelet transform, a Hankel transform, a Gabor transform, a Hadamard transform, a Shearlet transform, a quantum Fourier transform, and/or any other suitable transform can be performed.

As shown at lines 8 of FIG. 6, a tensor [symbol] ∈ [symbol] ^{H}^{₀}^{W}^{₀}^{n×m×B}, such that [symbol] (:, s, :)=\tilde{X}ₛ, s=1, . . . , m can next be formed.

Then, as shown at lines 9-12 of FIG. 6, the B independent sub-networks in FIG. 3 can be trained using any suitable technique for training a fully connected network, in some embodiments. Note that, in some embodiments, the training processes of the B sub-networks are independent and training of the B sub-networks can be implemented in parallel without communication between the networks.

As shown at line 10 of FIG. 6, the training input tensor at the b-th branch is \tilde{X}_{b}∈ [symbol] ^{H}^{₀}^{×W}^{₀}^{×n×m}, given by

$${\tilde{X}}_{b} ( : , : , : , s ) = fold ( {vec}^{- 1} ( \tilde{𝒳} ( : , s , b ) ) ) , s = 1 , … , m . \qquad ( 30 )$$

As shown at line 11 of FIG. 6, the training data set for the b-th sub-network can {(\tilde{X}_{b}(:, :, :, s), yₛ), s=1, . . . , m}.

After the B sub-networks are independently trained, as shown at line 13 of FIG. 6, the weights of each of the sub-networks can be set as described above in connection with equation (13).

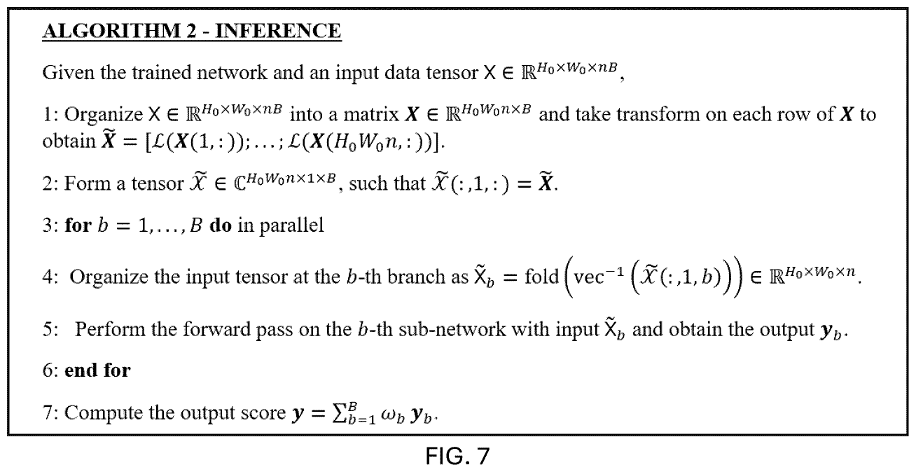

Once the convolutional spectral tensor network 300 is trained, the network can be used to infer scores for input data. FIG. 7 shows an example algorithm for using network 300 to infer scores.

As shown at line 1 of FIG. 7, given a new data sample X∈ [symbol] ^{H}^{₀}^{×W}^{₀}^{×nB}, the data sample can be organized into a matrix X∈ [symbol] ^{H}^{₀}^{W}^{₀}^{n×B} in the same manner as the training samples were organized. As also shown at line 1 of FIG. 7, a transform on each row of X can be taken to obtain \tilde{X}=[ [symbol] (X(1, :)); . . . ; [symbol] (X(H₀W₀n, :))]. Next, as shown at line 2 of FIG. 7, a tensor [symbol] ∈ [symbol] ^{H}^{₀}^{W}^{₀}^{n×1×B}, such that [symbol] (:, 1, :)=\tilde{X} can be formed. Then, as shown at lines 3-6 of FIG. 7, for each of the B sub-networks, the input tensor at the b-th branch can be organized as \tilde{X}_{b}=fold(vec⁻¹( [symbol] (:, 1, b)))∈ [symbol] ^{H}^{₀}^{×W}^{₀}^{×n} (line 4 of FIG. 7), and \tilde{X}_{b} can be input to the b-th sub-network to obtain the output y_{b}, b=1, . . . , B. Finally, at line 7 of FIG. 7, the final output can be computed as

$$y = {\sum }_{b = 1}^{B} {ω}_{b} {y}_{b} .$$

If it is assumed that Cⱼ=nB, j 32 0, 1, . . . , N, for a conventional convolutional layer, the weight tensor size is

$${H}_{j}^{′} \times {W}_{j}^{′} \times nB \times nB ,$$

and the computation complexity of equation (17) is

$${H}_{j}^{″} {W}_{j}^{″} {H}_{j}^{′} {W}_{j}^{′} {n}^{2} {B}^{2}$$

for the j-in layer, j=1, . . . , N. For the convolutional spectral tensor layer with B sub-networks in the spectral domain as described above, the size of the spectral weight tensor in each sub-network is

$${H}_{j}^{′} \times {W}_{j}^{′} \times n \times n$$

and the computation complexity of equation (25) is

$${H}_{j}^{″} {W}_{j}^{″} {H}_{j}^{′} {W}_{j}^{′} {n}^{2}$$

for the j-th layer, j=1, . . . , N. Therefore, the convolutional spectral tensor layer's speed is improved by O(B²) compared to a conventional convolutional layer.

### Federated Learning

In accordance with some embodiments, spectral tensor networks as described herein can be applied to a federated learning scenario of image classification where nodes have images with different resolutions.

In some embodiments, Federated learning (FL) enables mobile nodes (e.g., smartphones) to learn a collective model with the training data stored locally.

Consider a scenario where image data at different nodes have two levels of resolution, namely, high-resolution (HR) and low-resolution (LR) images, denoted by xₛ and xₛ′, respectively.

The HR/LR data can be modeled as follows, in some embodiments.

For HR input data vectors xₛ∈ [symbol] , s=1, . . . , m in line 1 of FIG. 4, xₛ∈ [symbol] can be organized into a matrix Xₛ∈ [symbol] , s=1, . . . , m. Then, in line 2-6 of FIG. 4, a transform [symbol] along each row of Xₛ, s=1, . . . , m, can be taken and the spectral data can be organized into a tensor [symbol] ∈ [symbol] , where Q is assumed to be even.

For LR data, high-band coefficients can be set to zero, i.e., [symbol] (:, :, q)=0 for q=Q/2+1, . . . , Q, and a inverse transform can be taken along the rows of each lateral slice (:, s, :), s=1, . . . , m to obtain the LR data

$${X}_{s}^{′} ∈ {ℝ}^{{ℓ}_{0} \times Q} , i . e . , {X}_{s}^{′} ( i , : ) = {ℒ}^{- 1} ( \tilde{𝒳} ( i , s , : ) ) ,$$

i=1, . . . , [symbol] ₀, s=1, . . . , m. Note that the LR data X′ can have the same size as the HR data, i.e., both have size [symbol] ₀×Q.

In some embodiments, federated learning with a fully connected spectral tensor network (as illustrated in connection with FIG. 1) can be performed as follows.

Suppose that nodes 1, 2, . . . , H are HR nodes and nodes H+1, H+2, . . . , 2H are LR nodes. A training process that can be used in accordance with some embodiments is as follows.

For HR nodes, the training data can be pre-processed to obtain [symbol] . As shown in lines 8-10 of FIG. 4, the Q independent sub-networks in FIG. 1 can be trained with the training data set for the q-th sub-network as {( [symbol] (:, s, q), yₛ), s=1, . . . , m}, q=1, . . . , Q.

For LR nodes, after pre-processing, the high-band coefficients are zeros, i.e., (:, :, q)=0 for q=Q/2+1, . . . , Q. Then, as shown in lines 8-10 of FIG. 4, Q/2 independent sub-networks in FIG. 1 can be trained with the training data set for the q-th sub-network as {( [symbol] (:, s, q), yₛ), s=1, . . . , m}, q=1, . . . , Q/2.

After all HR/LR nodes trained their local networks, each HR node can broadcasts its Q sub-networks to other HR nodes and its Q/2 low-band sub-networks to all LR nodes; each LR node broadcasts its Q/2 sub-networks to other LR nodes and all HR nodes.

Therefore, after training, each HR node has 3QH/2 sub-networks and each LR node has QH sub-networks.

In some embodiments, inference can be performed after such federated learning as follows.

For an HR node, given a new data sample x∈ [symbol] , the data sample can be matricized into X∈ [symbol] and then a transform can be taken along each row to obtain \tilde{X}. Next, the q-th column of \tilde{X}, i.e., \tilde{X}(:, q), can be input to each one of the sub-networks for the q-th sub-band, for q=1, . . . , Q. The final output can be the average of all sub-network outputs, i.e.,

$$y = \frac{1}{2 H} {\sum }_{h = 1}^{H} {\sum }_{q = 1}^{Q} {ω}_{q}^{h} {y}_{q}^{h} + \frac{1}{2 H} {\sum }_{h = H + 1}^{2 H} {\sum }_{q = 1}^{Q / 2} {ω}_{q}^{′ h} {y}_{q}^{′ h} , \qquad ( 31 )$$

$$where {\sum }_{q = 1}^{Q} {ω}_{q}^{h} = 1 for h = 1 , … , H and {\sum }_{q = 1}^{Q / 2} {ω}_{q}^{′ h} = 1 , for h = H + 1 , … , 2 H .$$

For an LR node, given a new data sample x∈ [symbol] , the data sample can be matricized into X∈ [symbol] and then a transform can be taken along each row to obtain \tilde{X}, whose last Q/2 columns are zeros. Next, the q-th column of \tilde{X}, i.e., \tilde{X}(:, q), can be input to each one of the sub-networks for the q-th sub-band, for q=1, . . . , Q/2. The final output can be the average of all sub-network outputs, i.e.,

$${y}^{′} = \frac{1}{2 H} {\sum }_{h = 1}^{H} {\sum }_{q = 1}^{Q / 2} 2 {ω}_{q}^{″ h} {y}_{q}^{h} + \frac{1}{2 H} {\sum }_{h = H + 1}^{2 H} {\sum }_{q = 1}^{Q / 2} {ω}_{q}^{′ h} {y}_{q}^{′ h} , \qquad ( 32 )$$

where the weights for HR nodes' sub-networks are normalized as

$${ω}_{q}^{″ h} = {ω}_{q}^{h} / {\sum }_{q = 1}^{Q / 2} {ω}_{q}^{h} ,$$

for q=1, 2, . . . , Q/2, h=1, . . . , H.

### Convolutional Spectral Tensor Neural Network

In accordance with some embodiments, a convolutional spectral tensor neural network with 2D transforms, based on a generalized spectral tensor product of 4th-order tensors, can be implemented.

In some embodiments, an operator MatView(⋅) can be defined as takeing a 4th-order tensor [symbol] ∈ [symbol] ⁿ^{₁}^{×n}^{₂}^{×n}^{₃}^{×n}^{₄} and returning an n₁n₃n₄×n₂n₃n₄ block diagonal matrix, with n₃n₄ blocks and each block being an n₁×n₂ matrix, defined as

$$\begin{matrix}MatV i ew ( ) = diag ( {A}_{1 , 1} , … , {A}_{k , ℓ} , … , {A}_{{n}_{3} , {n}_{4}} ) , \\ {A}_{k , ℓ} ( i , j ) = ( i , j , k , ℓ ) , i = 1 , … , {n}_{1} , \\ j = 1 , … , {n}_{2} , k = 1 , … , {n}_{3} , ℓ = 1 , … , {n}_{4} .\end{matrix} \qquad ( 35 )$$

In some embodiments, an operator TenView(⋅) can be defined as folding MatView( [symbol] ) back to tensor [symbol] , i.e.,

$$T e n V i e w ( M a t V i ew ( ) ) = . \qquad ( 36 )$$

In some embodiments, given two 4th-order tensors [symbol] ∈ [symbol] ⁿ^{₁}^{×n′×n}^{₃}^{×n}^{₄} and [symbol] ∈ [symbol] ^{n′×n}^{₂}^{×n}^{₃}^{×n}^{₄}, the corresponding (k, [symbol] )-th matrices are [symbol] ∈ [symbol] ⁿ^{₁}^{×n′} and [symbol] ∈ [symbol] ^{n′×n}^{₂}, and their multiplication is [symbol] = [symbol] ∈ [symbol] ⁿ^{₁}^{×n}^{₂}.

In some embodiments a matrix multiplication of two block diagonal matrices can be

$$MatView ( ) = MatView ( ) \cdot MatView ( ℬ ) , \qquad ( 37 )$$

where · denotes the conventional matrix multiplication.

The spectral tensor product in equation (1) can be extended to 4th-order tensors by using a 2D transform, in some embodiments.

In some embodiments, given an invertible discrete linear transform [symbol] : [symbol] ⁿ^{₃}^{×n}^{₄}→ [symbol] ⁿ^{₃}^{×n}^{₄}, let [symbol] and its inverse [symbol] ⁻¹ be taken on the third-and fourth-dimensions of 4th order tensors. That is, for [symbol] ∈ [symbol] ⁿ^{₁}^{×n}^{₂}^{×n}^{₃}^{×n}^{₄}, [symbol] = [symbol] ( [symbol] )∈ [symbol] ⁿ^{₁}^{×n}^{₂}^{×n}^{₃}^{×n}^{₄}, with [symbol] (i, j,:, :)= [symbol] ( [symbol] (i, j, :, :)), i=1, . . . , n₁, j=1, . . . , n₂. And for [symbol] ∈ [symbol] ⁿ^{₁}^{×n}^{₂}^{×n}^{₃}^{×n}^{₄}, [symbol] = [symbol] ⁻¹( [symbol] ), with [symbol] (i, j, :, :)= [symbol] ⁻¹( [symbol] (i, j, :, :)), i=1, . . . , n₁, j=1, . . . , n₂, in some embodiments.

In some embodiments, the generalized spectral tensor product with 2D transform [symbol] can be defined as

$$\begin{matrix}= •ℬ = {ℒ}^{- 1} ( T e n V i e w ( M a t V i e w ( {˜}^{} ) ) , \\ MatV i e w ( {˜}^{} ) = MatV i e w ( {˜}^{} ) \cdot MatV i e w ( \tilde{ℬ} ) .\end{matrix} \qquad ( 38 )$$

In some embodiments, assuming that Cⱼ=nB and B=B₁B₂ for j=0, . . . , N, then equation (22) can be extended to 4th-order tensors with 2D transforms

$${𝒴}^{j} = {𝒲}^{j} {•𝒳}^{j - 1} + {ℬ}^{j} , \qquad ( 39 )$$

where ⋅ is given in equation (38), [symbol] ^{j}∈ [symbol] ^{H}^{ⱼ}^{″W}^{ⱼ}^{″n×m×B}^{₁}^{×B}^{₂}, [symbol] ^{j}∈ [symbol] ^{H}^{ⱼ}^{′W}^{ⱼ}^{″n×H}^{_{j−1}}^{W}^{_{j−1}}^{n×B}^{₁}^{×B}^{₂}, [symbol] ^{j}∈ [symbol] ^{H}^{_{j−1}}^{W}^{_{j−1}}^{n×m×B}^{₁}^{×B}^{₂} and [symbol] ^{j}∈ [symbol] ^{H}^{ⱼ}^{″W}^{ⱼ}^{″n×m×B}^{₁}^{×B}^{₂}, respectively.

In some embodiments, for [symbol] ∈ [symbol] ^{H}^{₀}^{W}^{₀}^{n×m×B}^{₁}^{×B}^{₂}, denote [symbol] = [symbol] ( [symbol] )∈ [symbol] ^{H}^{₀}^{W}^{₀}^{n×m×B}^{₁}^{×B}^{₂} as the 2D transform of [symbol] along the third and fourth dimensions, i.e., [symbol] (i, s, :, :)= [symbol] ( [symbol] (i, s, :, :)), i=1, . . . , H₀W₀n, s=1, . . . , m. [symbol] can be used to denote the (k, [symbol] )-th block matrix in MatView( [symbol] ), k=1, . . . , B₁, [symbol] =1, . . . , B₂. Then, in some embodiments, equation (39) can be split into B₁B₂ parallel branches of matrix computations as follows

$$\begin{matrix}{\tilde{Y}}_{k , ℓ}^{j} = {\tilde{W}}_{k , ℓ}^{j} \cdot {\tilde{X}}_{k , ℓ}^{j - 1} + {\tilde{B}}_{k , ℓ}^{j} , \\ k = 1 , … , {B}_{1} , ℓ = 1 , … , {B}_{2} ,\end{matrix} \qquad ( 40 )$$

$$where {\tilde{Y}}_{k , ℓ}^{j} ∈ {ℂ}^{{H}_{j}^{″} {W}_{j}^{″} n \times m} , {\tilde{W}}_{k , ℓ}^{j} ∈ {ℂ}^{{H}_{j}^{″} {W}_{j}^{″} n \times {H}_{j - 1} {W}_{j - 1} n} , and {\tilde{X}}_{k , ℓ}^{j - 1} ∈ {ℂ}^{{H}_{j - 1} {W}_{j - 1} n \times m} .$$

In some embodiments, equation (40) can be converted back to a convolutional form as in equation (25), using an inverse mapping as in equation (24). In some embodiments, for the (k, [symbol] )-th branch in equation (40), the input is

$${\tilde{X}}_{k , ℓ}^{j - 1} ∈ {ℂ}^{{H}_{j - 1} \times {W}_{j - 1} \times n \times m} ,$$

the output feature map is [symbol] ∈ [symbol] ^{H}^{ⱼ}^{″×W}^{′×n×m}, and the kernel weight is

$${\tilde{W}}_{k , ℓ}^{j} ∈ {ℂ}^{{H}_{j}^{′} \times {W}_{j}^{′} \times n \times n} .$$

embodiments, for k=1, . . . , B₁, [symbol] =1, . . . , B₂, equation (40) can be rewritten as

$${\tilde{Y}}_{k , ℓ}^{j} ( h , w , c , : ) = {\sum }_{d = 1}^{n} {\sum }_{ℓ = 0}^{{W}_{j}^{′} - 1} {\sum }_{i = 0}^{{H}_{j}^{′} - 1} {\tilde{X}}_{k , ℓ}^{j - 1} ( h + i , w + ℓ , d , : ) \cdot {\tilde{W}}_{k , ℓ}^{j} ( i , ℓ , d , c ) + {\tilde{B}}_{k , ℓ}^{j} ( h , w , c , : ) , \qquad ( 41 )$$

$$h = 1 , … , {H}_{j}^{″} , w = 1 , … , {W}_{j}^{″} , c = 1 , … , n .$$

In some embodiments, the activation function can be applied in the spectral domain as follows

$${\tilde{Z}}_{k , ℓ}^{j} = σ ( {\tilde{Y}}_{k , ℓ}^{j} ) ∈ {ℂ}^{{H}_{j}^{″} \times {W}_{j}^{″} \times n \times m} . \qquad ( 42 )$$

Then, in some embodiments, a pooling operation can be performed at the j-th layer of each branch, resulting in the output

$${\tilde{X}}_{k , ℓ}^{j} ∈ {ℂ}^{{H}_{j} \times {W}_{j} \times n \times m} .$$

At the last layer, in some embodiments, the output function f(⋅) can be applied to

$${\tilde{X}}_{k , ℓ}^{N} ,$$

as in equation (19), i.e.,

$${Y}_{k , ℓ} = f ( {\tilde{X}}_{k , ℓ}^{N} ) , k = 1 , … , {B}_{1} , ℓ = 1 , … , {B}_{2} . \qquad ( 43 )$$

Finally, in some embodiments, the network output can be the weighted sum of the

outputs of the B₁B₂ branches, i.e.,

$$Y = {\sum }_{k = 1}^{{B}_{1}} {\sum }_{ℓ = 1}^{{B}_{2}} {ω}_{k , ℓ} {Y}_{k , ℓ} , s . t . {ω}_{k , ℓ} \geq 0 , {\sum }_{k = 1}^{{B}_{1}} {\sum }_{ℓ = 1}^{{B}_{2}} {ω}_{k , ℓ} = 1. \qquad ( 44 )$$

In some embodiments, the spectral convolutional tensor network takes a similar structure as in FIG. 3 with B₁B₂ branches. In some embodiments, the network includes B₁B₂ independent convolutional sub-networks, with the (k, [symbol] )-th sub-network operating on the (k, [symbol] )-th input sub-tensor [symbol] and producing the corresponding output score vector [symbol] .

For each input tensor X∈ [symbol] ^{H}^{₀}^{×W}^{₀}^{×nB}^{₁}^{B}^{₂}, the spectral domain input sub-tensors [symbol] ∈ [symbol] ^{H}^{₀}^{×W}^{₀}^{33 n}, k=1, . . . , B₁, [symbol] =1, . . . , B₂ can be formed.

The network output score is the weighted sum of all sub-network scores, in some embodiments.

The weight tensor [symbol] ^{j} in equations (5)-(6) can have a low tubal-rank such that [symbol] ^{j}= [symbol] ^{j}· [symbol] ^{j}, where [symbol] ^{j}∈ [symbol] , [symbol] ^{j}∈ [symbol] , and r<<min{ [symbol] ₀, . . . , [symbol] _{N}}, in some embodiments. Correspondingly, the weight matrix of each branch can have a low-rank structure, i.e.,

$${\tilde{W}}_{q}^{j} = {\tilde{C}}_{q}^{j} \cdot {\tilde{D}}_{q}^{j} , q = 1 , … , Q , \qquad ( 45 )$$

$$where {\tilde{C}}_{q}^{j} ∈ {ℂ}^{{ℓ}_{j} \times r} and {\tilde{D}}_{q}^{j} ∈ {ℂ}^{r \times {ℓ}_{j - 1}} .$$

Then, in some embodiments, equations (8)-(9) become

$${\tilde{Z}}_{q}^{j} = {\tilde{D}}_{q}^{j} \cdot {\tilde{X}}_{q}^{j - 1} , j = 1 , … , N , \qquad ( 46 )$$

$${\tilde{X}}_{q}^{j} \& = σ ( {\tilde{C}}_{q}^{j} \cdot {\tilde{Z}}_{q}^{j} + {\tilde{B}}_{q}^{j} ) , j = 1 , … , N - 1 , \qquad ( 47 )$$

$${\tilde{X}}_{q}^{N} = {\tilde{C}}_{q}^{N} \cdot {\tilde{Z}}_{q}^{N} , \qquad ( 48 )$$

$$where {\tilde{Z}}_{q}^{j} ∈ {ℂ}^{r \times m} ,$$

q=1, . . . , Q. and in the output layer with j=N,

$${\tilde{B}}_{q}^{j}$$

is zero and σ(⋅) is an identity function.

Therefore, in accordance with some embodiments, an N-layer fully connected spectral tensor network in equations (5)-(6) can be split into a 2N-layer network, such that each layer in equation (8) is implemented by two sub-layers, namely a linear layer equation (46) and a nonlinear layer equation (47), while the N-th layer in equation (9) is implemented by two linear sub-layers, namely equation (46) and equation (48).

### Convolutional Network

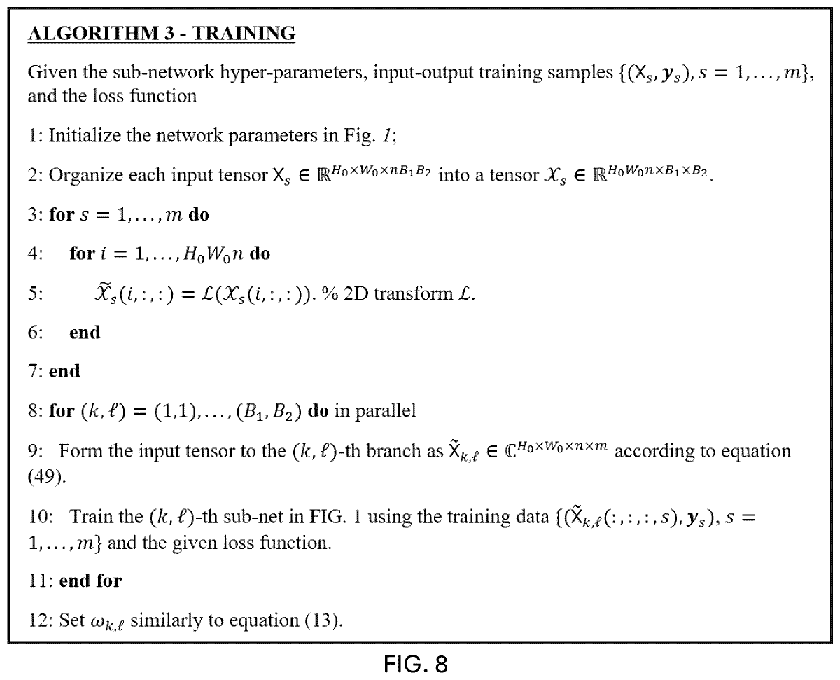

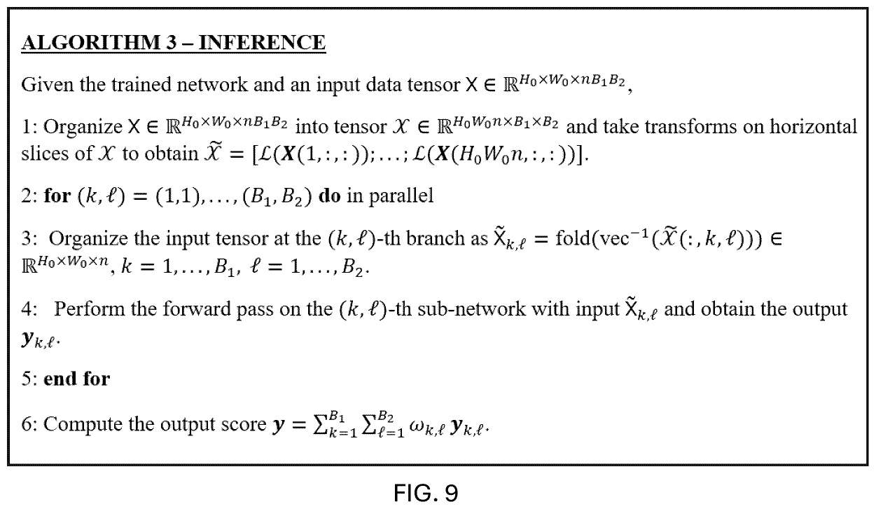

Turning to FIGS. 8 and 9, additional algorithms for training and using a network to infer in accordance with some embodiments are shown.

In some embodiments, assume that a training dataset contains m samples, i.e., {(Xₛ, yₛ), s=1, . . . , m}, where Xₛ∈ [symbol] ^{H}^{₀}^{×W}^{₀}^{×nB}^{₁}^{B}^{₂} is the data sample and yₛ∈ [symbol] ^{L} is the corresponding score.

As shown at line of FIG. 8, the algorithm can initialize any suitable network parameters in any suitable manner, such as that described above in connection with line 1 of FIG. 6.

Next, as shown at line 2 of FIG. 8, each input tensor Xₛ∈ [symbol] ^{H}^{₀}^{×W}^{₀}^{×nB}^{₁}^{B}^{₂} can be organized into a third-order tensor [symbol] ₛ∈ [symbol] ^{H}^{₀}^{W}^{₀}^{n×B}^{₁}^{×B}^{₂}. This organizing can be performed in any suitable manner in some embodiments. For example, in some embodiments, one way of performing the organizing can be: for example, if Xₛ is 32×32×(8*4*4); then this third-order tensor can be organized into eight group so 4×4, in some embodiments.

Then, as shown at lines 3-7 of FIG. 8, a 2D transform on each horizontal slice of [symbol] ₛ can be taken to obtain [symbol] ₛ∈ [symbol] ^{H}^{₀}^{W}^{₀}^{n×B}^{₁}^{×B}^{₂} such that [symbol] (i, :, :)= [symbol] ( [symbol] (i, :, :)), i=1, . . . , H₀W₀n.

At lines 8-11 of FIG. 8, the tensor [symbol] ∈ [symbol] ^{H}^{₀}^{W}^{₀}^{n×m×B}^{₁}^{×B}^{₂}, such that [symbol] (:, s, :, :)= [symbol] ₛ, is formed (line 9 of FIG. 8) and each branch if trained (line 10 of FIG. 8).

In some embodiments, the input tensor at the (k, [symbol] )-th branch can be [symbol] ∈ [symbol] ^{H}^{₀}^{×W}^{₀}^{×n×m}, given by

$${\tilde{X}}_{k , ℓ} ( : , : , : , s ) = fold ( {vec}^{- 1} ( \tilde{𝒳} ( : , s k , ℓ ) ) ) , \qquad ( 49 )$$

$$k = 1 , … , {B}_{1} , ℓ = 1 , … , {B}_{2} , s = 1 , … , m .$$

Then, in some embodiments, using any suitable mechanism for training a convolutional network, the B₁B₂ independent sub-networks can be trained.

In some embodiments, the common parameters can be set. Any suitable parameters can be set in any suitable manner. For example, in some embodiment, the number of layers N, the convolutional kernel sizes

$${H}_{j}^{′} \times {W}_{j}^{′} \times n \times n ,$$

the activation function σ(⋅), the pooling function, and the loss function can be set in any suitable manner.

The training dataset for the (k, [symbol] )-th sub-network is {( [symbol] (:, ;, s), yₛ), s=1, . . . , m}, in some embodiments.

In some embodiments, after the B₁B₂ sub-networks are independently trained, the weights of the (k, [symbol] )-th sub-networks can be set similarly to equation (13), as shown at line 12 of FIG. 8.

Once the convolutional spectral tensor network has been trained, the network can be used to infer scores for input data. FIG. 9 shows an example algorithm for using the network to infer scores.

As shown at line 1 of FIG. 9, given a new data sample X∈ [symbol] ^{H}^{₀}^{×W}^{₀}^{×nB}^{₁}^{B}^{₂}, the data sample can be organized into a tensor [symbol] ∈ [symbol] ^{H}^{₀}^{W}^{₀}^{n×B}^{₁}^{×B}^{₂} in the same manner as the training samples were organized. As also shown at line 1 of FIG. 9, a 2D transform on each horizontal slice of [symbol] can be taken to obtain [symbol] ∈ [symbol] ^{H}^{₀}^{W}^{₀}^{n×B}^{₁}^{×B}^{₂}, such that [symbol] (i, :, :)= [symbol] ( [symbol] (i, :, :)), i=1, . . . , H₀W₀n. Next, as shown at lines 2-5 of FIG. 9, the input tensor at the (k, [symbol] )-th branch can be organized as [symbol] =fold(vec⁻¹( [symbol] (:, k, [symbol] )∈ [symbol] ^{H}^{₀}^{×W}^{₀}^{×n}, k=1, . . . , B₁, [symbol] =1, . . . , B₂ (line 3 of FIG. 9) and [symbol] can be input to the (k, [symbol] )-th sub-network to obtain the output [symbol] k=1, . . . , B₁, [symbol] =1, . . . , B₂.

At line 6 of FIG. 9, the final output can the be computed as

$$y = {\sum }_{k = 1}^{{B}_{1}} {\sum }_{ℓ = 1}^{{B}_{2}} {ω}_{k , ℓ} {y}_{k , ℓ} .$$

If it is assumed that Cⱼ=nB and B=B₁B₂, j=0, 1, . . . , N, then for the conventional convolutional layer the weight tensor size is

$${H}_{j}^{′} \times {W}_{j}^{′} \times n {B}_{1} {B}_{2} \times n {B}_{1} {B}_{2} ,$$

complexity of conventional convolutional layer is

$${H}_{j}^{″} {W}_{j}^{″} {H}_{j}^{′} {W}_{j}^{′} {n}^{2} {B}_{1}^{2} {B}_{2}^{2}$$

for the j-th layer, j=1, . . . , N, in some embodiments. In some embodiments, for the convolutional spectral tensor layer with B₁B₂ sub-networks in the spectral domain, the size of the spectral weight tensor in each sub-network is

$${H}_{j}^{′} \times {W}_{j}^{′} \times n \times n$$

and the computation complexity of equation (41) is

$${H}_{j}^{″} {W}_{j}^{″} {H}_{j}^{′} {W}_{j}^{′} {n}^{2}$$

for the j-th layer, j=1, . . . , N. Therefore, the speedup is

$$O ( {B}_{1}^{2} {B}_{2}^{2} ) .$$

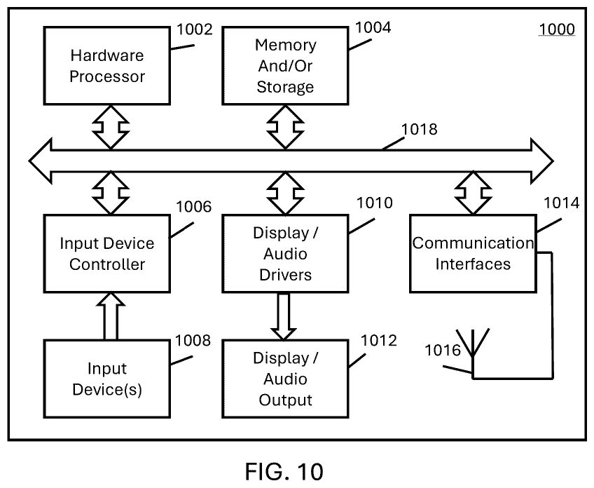

The networks and sub-networks described herein can be implemented in any suitable computing devices. For example, in some embodiments, the networks and sub-networks described herein can be implemented using any suitable general-purpose computer or special-purpose computer(s). Any such general-purpose computer or special-purpose computer can include any suitable hardware. For example, as illustrated in example hardware 1000 of FIG. 10, such hardware can include hardware processor 1002, memory and/or storage 1004, an input device controller 1006, an input device 1008, display/audio drivers 1010, display and audio output circuitry 1012, communication interface(s) 1014, an antenna 1016, and a bus 1018.

Hardware processor 1002 can include any suitable hardware processor, such as a graphical processing unit (GPU), a tensor processing unit (TPU), a microprocessor, a micro-controller, digital signal processor(s), dedicated logic, and/or any other suitable circuitry for controlling the functioning of a general-purpose computer or a special purpose computer in some embodiments.

Memory and/or storage 1004 can be any suitable memory and/or storage for storing programs, data, and/or any other suitable information in some embodiments. For example, memory and/or storage 1004 can include random access memory, read-only memory, flash memory, hard disk storage, optical media, and/or any other suitable memory.

Input device controller 1006 can be any suitable circuitry for controlling and receiving input from input device(s) 1008, in some embodiments. For example, input device controller 1006 can be circuitry for receiving input from an input device 1008, such as a touch screen, from one or more buttons, from a voice recognition circuit, from a microphone, from a camera, from an optical sensor, from an accelerometer, from a temperature sensor, from a near field sensor, an automobile navigation system, from a global positioning system, and/or any other type of input device.

Display/audio drivers 1010 can be any suitable circuitry for controlling and driving output to one or more display/audio output circuitries 1012 in some embodiments. For example, display/audio drivers 1010 can be circuitry for driving one or more display/audio output circuitries 1012, such as an LCD display, a speaker, an LED, or any other type of output device.

Communication interface(s) 1014 can be any suitable circuitry for interfacing with one or more communication networks. For example, interface(s) 1014 can include network interface card circuitry, wireless communication circuitry, and/or any other suitable type of communication network circuitry.

Antenna 1016 can be any suitable one or more antennas for wirelessly communicating with a communication network in some embodiments. In some embodiments, antenna 1016 can be omitted when not needed.

Bus 1018 can be any suitable mechanism for communicating between two or more components 1002, 1004, 1006, 1010, and 1014 in some embodiments.

Any other suitable components can additionally or alternatively be included in hardware 1000 in accordance with some embodiments.

It should be understood that at least some of the above-described operations of the algorithms of FIGS. 4-9 can be executed or performed in any order or sequence not limited to the order and sequence shown in and described in the figures. Also, some of the above operations of the algorithms of FIGS. 4-9 can be executed or performed substantially simultaneously where appropriate or in parallel to reduce latency and processing times. Additionally or alternatively, some of the above-described operations of the algorithms of FIGS. 4-9 can be omitted

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable non-transitory tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for training a distributed neural network, comprising:
memory; and
at least one hardware processor coupled to the memory and collectively configured to at least:
for each of a plurality of sub-networks:
perform a transform on data in a data structure having at least two dimensions to provide training data having a higher dimensionality than the at least two dimensions; and
train the sub-network using the training data independently of other of the plurality of subnetworks.

2. The system of claim 1, wherein the at least two dimensions is two dimensions.

3. The system of claim 1, wherein the training data is stored in a three-dimensional structure.

4. The system of claim 1, wherein the transform is a discrete Fourier transform.

5. The system of claim 1, wherein the transform is a discrete cosine transform.

6. The system of claim 1, wherein the at least one hardware processor is further configured to map the training data from a data structure having a first dimensionality to a data structure having a higher dimensionality and fold the training data prior to training the sub-network.

7. A method for training a distributed neural network, comprising:
for each of a plurality of sub-networks:
performing, using a hardware processor, a transform on data in a data structure having at least two dimensions to provide training data having a higher dimensionality than the at least two dimensions; and
training the sub-network using the training data independently of other of the plurality of subnetworks.

8. The method of claim 7, wherein the at least two dimensions is two dimensions.

9. The method of claim 7, wherein the training data is stored in a three-dimensional structure.

10. The method of claim 7, wherein the transform is a discrete Fourier transform.

11. The method of claim 7, wherein the transform is a discrete cosine transform.

12. The method of claim 7, further comprising mapping the training data from a data structure having a first dimensionality to a data structure having a higher dimensionality and folding the training data prior to training the sub-network.

13. A non-transitory computer-readable medium containing computer executable instructions that, when executed by a processor, cause the processor to perform a method for training a distributed neural network, the method comprising:
for each of a plurality of sub-networks:
performing a transform on data in a data structure having at least two dimensions to provide training data having a higher dimensionality than the at least two dimensions; and
training the sub-network using the training data independently of other of the plurality of subnetworks.

14. The non-transitory computer-readable medium of claim 13, wherein the at least two dimensions is two dimensions.

15. The non-transitory computer-readable medium of claim 13, wherein the training data is stored in a three-dimensional structure.

16. The non-transitory computer-readable medium of claim 13, wherein the transform is a discrete Fourier transform.

17. The non-transitory computer-readable medium of claim 13, wherein the transform is a discrete cosine transform.

18. The non-transitory computer-readable medium of claim 13, wherein the method further comprises mapping the training data from a data structure having a first dimensionality to a data structure having a higher dimensionality and folding the training data prior to training the sub-network.
